(19) United States
(12) Patent Application Publication
(10) Pub. No.: US 2026/0284911 A1
(43) Pub. Date: Sep. 24, 2026

(54) COUPLING ARRANGEMENT

(71) Applicant: RENISHAW PLC, Wotton-under-Edge, Gloucestershire (GB)

(72) Inventor: Stephen Mark ANGOOD, Portreath (GB)

(73) Assignee: RENISHAW PLC, Wotton-under-Edge, Gloucestershire (GB)

(21) Appl. No.: 19/477,739

(22) PCT Filed: May 2, 2024
(86) PCT No.: PCT/GB2024/051155

§ 371 Date: Oct. 22, 2025

(30) Foreign Application Priority Data
May 4, 2023 (GB) 2306606.1

(51) Int. Cl. B25J 19/06

(52) U.S. Cl. CPC B25J 19/063

(57) ABSTRACT

A coupling arrangement is provided for coupling a measurement device to a coordinate positioning machine, wherein the coupling arrangement is adapted to provide over-travel protection for the measurement device when the measurement device is moved relative to the coupling arrangement towards an interface therebetween. The coupling arrangement is advantageously adapted to provide over-travel protection by causing the measurement device to become at least partially decoupled from the machine. The coupling arrangement is advantageously adapted such that the measurement device remains partially coupled to the machine when in an over-travel state.

The present invention relates to a coupling arrangement for coupling a measurement device to a machine. The present invention relates in particular, but not exclusively, to a coupling arrangement for coupling a measurement probe such as a touch-trigger measurement probe to a coordinate positioning machine such as an articulated robot.

Articulated robots are commonly used in a wide variety of manufacturing applications such as assembly, welding, gluing, painting, picking and placing (e.g. for printed circuit boards), packaging and labelling, palletizing, and product inspection. They benefit from being versatile and rugged, with a large reach and a high degree of flexibility of movement, making them ideal for use in a production environment.

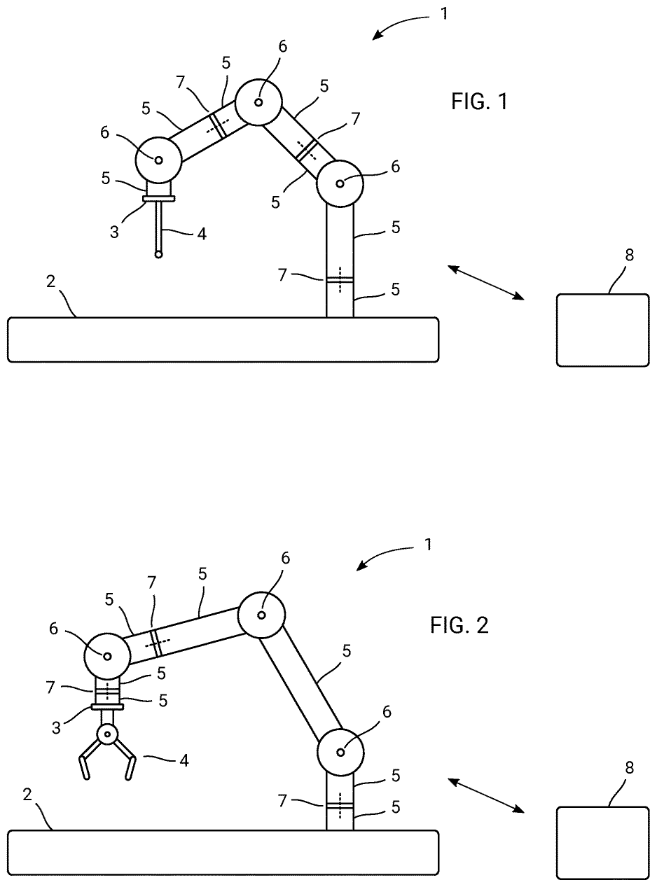

An articulated robot (or just “robot” for short) is illustrated schematically in FIG. 1 of the accompanying drawings, comprising an articulated robot arm 1 extending from a fixed base 2 to a moveable flange 3, with the flange 3 supporting a tool (or end effector) 4. Typically, the flange 3 is provided with a coupling which allows for the tool 4 to be conveniently interchangeable, so that a variety of tools, devices or end effectors can be employed depending on the application concerned; examples include grippers, vacuum cups, cutting tools (including both mechanical and laser cutting tools), drilling tools, milling tools, deburring tools, welding tools and other specialized tools or devices.

The arm 1 comprises a plurality of segments 5 connected by a mixture of transverse rotary axes 6 and inline (or longitudinal) rotary axes 7, forming a mechanical linkage from one end to the other. In the example illustrated in FIG. 1, there are three transverse rotary axes 6 and three inline rotary axes 7, making a total of six rotary axes, alternating between transverse rotary axes 6 and inline rotary axes 7. An additional inline rotary axis 7 (not shown in FIG. 1) could also be provided between the final transverse rotary axes 6 and the flange 3, to provide convenient rotation of the tool 4 around its longitudinal axis, making a total of seven rotary axes.

Another common arrangement is shown in the arm 1 of FIG. 2, which includes the additional inline rotary axis 7 mentioned above, between the final transverse rotary axis 6 and the flange 3, and which also omits the second inline rotary axis 7 from FIG. 1 (in series order from the base end to the head end), thereby making a total of six rotary axes. The tool 4 in FIG. 2 is a gripper. The arm 1 of FIG. 1 is a schematic representation of the well-known IRB 140 six-axis industrial robot by ABB Robotics. The final three axes 6, 7 form a “wrist” of the robot arm 1, with the centre of the wrist being at the centre of the final transverse rotary axis 6. The centre of the wrist is invariant to rotation of the three rotary axes 6, 7 of the wrist, such that operation of the three rotary axes 6, 7 changes the orientation of whatever is attached to the wrist (in this case the gripper 4) without changing the position of the wrist centre, with the first three rotary axes 6, 7 of the robot arm 1 determining the position of the wrist centre. The wrist may be readily detachable from the remainder of the arm 1.

The articulated robot arms 1 of FIGS. 1 and 2 are examples of a non-Cartesian coordinate positioning machine because, in contrast to a Cartesian machine such as a traditional three-axis (X, Y, Z) coordinate measuring machine (see for example FIG. 1 of PCT/GB2020/052593), its axes are not arranged orthogonally according to a Cartesian coordinate system. The arms 1 of FIGS. 1 and 2 are also examples of a “serial kinematic” coordinate positioning machine, because their axes of movement are arranged in series. In this sense, such a machine is similar to a traditional three-axis Cartesian coordinate measuring machine, which is also an example of a “serial kinematic” coordinate measuring machine, and is to be contrasted with a “parallel kinematic” coordinate positioning machine such as a hexapod whose axes of movement are arranged instead in parallel.

Each joint or axis in a coordinate positioning machine contributes a positional error or uncertainty. In a serial kinematic machine such as that shown in FIGS. 1 and 2, because of the serial nature of the linkages, these errors are cumulative. Whilst this accumulation of positional errors does not occur in the same sense with a parallel kinematic machine, regardless of machine type it is important to calibrate the machine in order to map out these errors or uncertainties. When properly calibrated, with the various geometrical parameters of the machine being known (such as the length of each of the segments 5 and the rotation angle offset of each of the rotary axes or joints 6, 7), it is possible to predict with more certainty in what position the tool 4 will actually be when the various axes or joints 6, 7 are commanded by a robot controller 8 to move to different respective positions. In other words, the machine parameters resulting from such a calibration provide a more accurate characterisation of the machine geometry.

Calibration of any type of non-Cartesian machine is a significant challenge, and particularly so for an articulated arm such as that illustrated in FIGS. 1 and 2 having a plurality of rotary axes that are: (a) arranged in series; (b) are not fixed relative to one another; and (c) that can combine in complicated ways to position the tool in the working volume. Calibration of a Cartesian machine is typically more straightforward, because such a machine has three well-defined axes that are fixed relative to one another in an orthogonal arrangement, with each axis being largely independent of another. With an articulated robot, the position and orientation of each axis depends on the position and orientation of each other axis, so that the calibration will be different for each different machine pose. These concepts, relating to calibration of coordinate positioning machines in general, and robot arms in particular, are explored in greater detail in patent publications WO 2019/162697 A1, WO 2021/116685 A1, and WO 2023/170166 A1.

However, even after using known calibration techniques, due to the challenges associated with calibrating a non-Cartesian machine such as shown in FIGS. 1 and 2, errors will typically remain. As a result, the accuracy of such a machine is typically not as good as that of a traditional three-axis Cartesian machine, for example, meaning that it would typically find use for assembly (e.g. pick-and-place) tasks in a manufacturing environment, such as the arrangement illustrated in FIG. 2, where speed, reach and flexibility are more important than absolute positioning accuracy, and would not typically be considered suitable for measurement tasks.

Furthermore, for any errors that do remain even after calibration, or any errors that arise after calibration (for example when components wear or drift from their intended positions), and particularly for cumulative errors associated with a serial kinematic non-Cartesian machine like a robot arm, the resulting positioning errors may be large enough to cause a problem whereby a delicate tool or instrument at the end of the kinematic chain is not where it is expected be (based on the calibrated machine parameters) and is damaged when it is inadvertently moved by the machine into an immoveable object in the workspace.

This problem can also occur, regardless of calibration and often with the most damaging consequences, if the machine is under manual (human) control, which is often the case for articulated robots during setup, or where the motion control system used to control the machine has been programmed incorrectly. The short range of travel typically associated with contact probes would normally preclude their use on machines having relatively inaccurate motion control, long stopping distances and high speeds, such as is the case with robot arms.

According to a first aspect of the present invention, there is provided a coupling arrangement for coupling a measurement device to a coordinate positioning machine, wherein the coupling arrangement is adapted to provide (additional and/or independent) over-travel protection for the measurement device when the measurement device is coupled to the machine via the coupling arrangement and is moved relative to the coupling arrangement in a predetermined direction towards (and/or transverse to) an interface between the measurement device and the coupling arrangement.

A coupling arrangement embodying the present invention is advantageous because it can be used as part of a modular and adaptive system in which a robot arm can be used for traditional tasks such as assembly, which makes use of tools that are purposefully designed in a robust manner for use on a robot arm in a harsh workshop environment, and then also used for measurement tasks using an existing measurement probe that is more delicate and not specifically designed with robustness in mind. A readily available measurement probe can beneficially be used, without modification, and coupled to the robot arm via a coupling arrangement embodying the present invention, with the coupling arrangement adding a level of over-travel protection for the measurement probe to enable it to cope with the harsher treatment that might be expected (compared to a more controlled environment on a traditional coordinate measuring machines). In other words, there is no need to provide a specific and re-designed version of the measurement probe for these environments. However, an embodiment of the present invention is not limited to use on a robot arm and will find use with any coordinate positioning machine if over-travel protection is required for any reason.

The coupling arrangement may be adapted to provide the over-travel protection by causing the device (coupled to the machine via the coupling arrangement) to become (or at least tend to become) at least partially decoupled from the machine. This may occur when the device is moved relative to the coupling arrangement towards the interface therebetween (e.g. directly towards the interface), at least by more than a predetermined distance and/or with more than a predetermined force. Without the decoupling action provided by such a coupling arrangement, this type of movement would otherwise cause the measurement device to be pushed and compressed into an unyielding coupling, thereby creating undesirable (and potentially damaging) compressive forces to be developed in the measurement device. When the device has become at least partially decoupled from the machine in this way, this may be referred to as being in an over-travel state or condition, or an at least partially decoupled state or condition.

By becoming at least partially decoupled when such a movement occurs, a range of additional relative movement is thereby provided between the device and the machine in that direction (which would not otherwise be available) without causing damage to the measurement device. The movement may be along a predetermined axis of the measurement device. The predetermined axis may be a Z axis of the measurement device. The predetermined axis may be a generally longitudinal axis of the measurement device. The predetermined axis may be an axis of the measurement device having the smallest available travel (of all the available measurement axes associated with the measurement device). For a typical measurement probe the smallest available travel would typically be along the Z axis (or generally longitudinal axis of probe), with a greater range of travel typically being available in the X and Y directions (corresponding to lateral deflections transverse to the Z axis or generally longitudinal axis of the probe).

The above-mentioned first aspect of the present invention may alternatively be stated as providing a coupling arrangement that is adapted to provide (additional and/or independent) over-travel protection for the measurement device when the measurement device is coupled to the machine via the coupling arrangement and is moved relative to the coupling arrangement along the predetermined axis of the measurement device (for example towards the interface between the measurement device and the coupling arrangement).

The coupling arrangement may be adapted to keep the device partially coupled to the machine when in an over-travel state (whilst allowing additional relative movement between the device and the machine). Not only does this ensure that the device does not fall off the machine completely, but it also facilitates re-coupling of the device to the machine via the coupling arrangement.

The coupling arrangement may be adapted to constrain the device relative to the machine in six degrees of freedom when in a coupled state. The coupling arrangement may be adapted such that the device remains coupled to the machine in at least one degree of freedom when in an over-travel state (or at least tends to do so). In other words, the coupling arrangement may be adapted such that the device remains constrained relative to the machine in at least one degree of freedom (or by at least one constraint to relative motion). In doing so, the device remains at least partially coupled to the machine when in an over-travel condition.

The coupling arrangement may be adapted such that the device becomes decoupled from the machine in a single degree of freedom and remains coupled to the machine in the other five (of six available) degrees of freedom when in an over-travel state (or at least tends to do so). In other words, the coupling arrangement may be adapted such that the device remains constrained relative to the machine in five degrees of freedom (or by five constraints to relative motion), with relative movement being available in just a single remaining degree of freedom. This is beneficial because, should there be a general move back towards (i.e. rather than away from) the original coupled state, the device will inevitably end up back to the same coupled state again because, with only one degree of freedom available for relative movement, there is no possibility to deviate from the original starting point. The five remaining constraints to relative motion may define a rotational axis about which the device rotates or pivots relative to the machine.

The single degree of freedom (i.e. that remaining available for relative movement after a single constraint is effectively removed) may be a rotational degree of freedom. The single constraint may be a constraint to relative rotational movement between the device and the machine.

The coupling arrangement may be adapted to recouple the device to the machine (when no longer in an over-travel state) in the same relative position and orientation as it was before becoming at least partially decoupled. In other words, the relative position and orientation defined by the coupling arrangement is preferably repeatable. It is particularly beneficial in a measurement context that the measurement device reseats back in the same (repeatable) position and orientation, because if the measurement device were to reseat back in a different position and/or orientation after an over-travel event then the measurement data before and after the event would not be consistent.

The coupling arrangement may be adapted to provide a kinematic or pseudo-kinematic coupling between the device and machine (when in a coupled state).

The coupling arrangement may be adapted to constrain the device relative to the machine in six degrees of freedom (when in a coupled state). The coupling arrangement may define six points of contact which are mutually arranged to constrain the device relative to the machine in six corresponding degrees of freedom (when in a coupled state), thereby providing exact or kinematic constraint in six degrees of freedom. When in an at least partially decoupled state, one or more of these points of contact is lost, thereby losing one or more corresponding respective degrees of freedom of constraint. These points of contact need not be (and in practice would not be) mathematical points in the pure sense. Instead, in practice, each of these would be a small area that approximates a point, and as such can be referred to as a pseudo point of contact.

The six points (or pseudo points) may be arranged across three locations in a “1-2-3” configuration. In other words, the six points (or pseudo points) of contact may be arranged with one point at a first location (providing a single constraint to relative movement between the device and the machine), two points at a second location (providing two constraints to relative movement) and three points at a third location (providing three constraints to relative movement).

The coupling arrangement may be adapted to become decoupled (when in an over-travel state) at a single point (or constraint) and remain coupled at the other five points (or constraints). The device thereby remains constrained relative to the machine in five degrees of freedom, leaving only a single degree of freedom for relative movement. The single point may provide constraint to relative motion between the device and machine in a rotational degree of freedom. The coupling arrangement may be adapted to become decoupled consistently at the same single point (or constraint).

The six points of contact may be arranged across three locations in a “2-2-2” configuration.

A plane defined by the points of contact may be arranged at an angle to the predetermined axis of the measurement device. The angle may be an acute angle. The angle may be between 20 and 70 degrees. The angle may be between 35 and 55 degrees. The angle may be approximately 45 degrees.

The points of contact may be offset from the predetermined axis of the measurement device.

The coupling arrangement may comprise a retaining mechanism which is adapted to prevent the device from falling off and/or away from the machine completely, even after the device has become decoupled from the machine in all six degrees of freedom (or at all six constraints or points of contact) referred to above.

The retaining mechanism may be adapted to become effective only when the coupling arrangement is in an over-travel state.

The retaining mechanism may be adapted to prevent the device from becoming decoupled from the machine in the at least one degree of freedom referred to above (i.e. where it is stated that the coupling arrangement may be adapted such that the device remains coupled to the machine in at least one degree of freedom when in an over-travel state).

The at least one degree of freedom in this context may be the five degrees of freedom referred to above (i.e. where it is stated that the coupling arrangement may be adapted such that the device remains constrained relative to the machine in five degrees of freedom, or by five constraints to relative motion).

Where the five constraints define a rotational or pivot axis as mentioned above, the retaining mechanism would prevent the device from coming off this axis, such that it still has a chance of rotating or pivoting back to the original coupled state around this axis.

These five constraints may be provided by the “2-3” part of the “1-2-3” configuration referred to above, or in other words the retaining mechanism may be adapted to prevent the device from becoming decoupled from the machine at those locations that provide two and three points of contacts (or constraints).

The retaining mechanism may be adapted to prevent relative movement in any remaining degree(s) of freedom beyond a predetermined limit, for example to prevent rotation or pivoting around an axis in the case of a single remaining rotational degree of freedom.

The retaining mechanism may be adapted to allow removal of the device from the machine only when in a predetermined relative orientation (for example when not pivoted or rotated relative to one another around an axis in the case of a single remaining rotational degree of freedom).

The coupling arrangement may be adapted to decouple the device at least partially from the machine when the device is moved relative to the coupling arrangement in a direction (or along a line or along an axis) which intersects the interface between the device and the coupling arrangement.

The coupling arrangement may be adapted to (or which may tend to) decouple (or disengage or break or change to a decoupled state from a coupled state) when the coupled parts are moved generally towards each other (rather than or as well as generally away from each other). In other words, the coupling arrangement may be a reverse coupling arrangement or have a reverse coupling configuration. The reverse coupling arrangement may be a reverse kinematic (or at least pseudo kinematic) coupling arrangement.

The over-travel protection provided by the coupling arrangement may be independent of and/or separate from and/or in addition to any over-travel which could be said to be provided internally within the measurement device itself. For example, a touch trigger probe typically allows a small amount of travel after a touch is made in the Z direction (i.e. along the stylus). However, this is because the transducer that is used in such a probe to convert a physical stimulus (i.e. a touch) into a signal relies on some additional movement to enable a touch to be detectable from the signal (so that the signal shows a clear transition from a non-contact state to a contact state, and to distinguish from noise). Therefore, a small range of travel in the Z direction is typically needed to accommodate normal operation of the transducer. It is also not possible in practice to stop the machine exactly when a touch occurs (there may also be a short time delay after the touch occurs and before the machine can be stopped), and the normal range of travel can also accommodate this. However, this is considered in the context of the present application to amount to a normal range of travel rather than over-travel as such.

The measurement device may comprise a sensor or transducer which is adapted to convert a physical stimulus (such as a touch between a workpiece-contacting part of the measurement device and a workpiece being measured by the measurement device) into an electrical signal. The measurement device may be considered to be a fully functional or standalone measurement device and not e.g. just the stylus of a touch trigger probe.

The measurement device may be a contact measurement device or a non-contact measurement device. A contact measurement device may be considered to be a type of measurement device in which a measurement is triggered by contact with the object (e.g. workpiece) being measured.

The measurement device may be a measurement probe.

The measurement device may be a touch trigger measurement probe. The measurement probe may comprise a workpiece-contacting stylus. The direction of over-travel protection (or the predetermined direction) may be along a generally longitudinal axis of the stylus. The predetermined direction (or the generally longitudinal axis of the stylus) may be referred to as or coincide with the Z axis of the measurement probe.

In the context of the present application, such a stylus does not constitute a measurement device but may form part of a measurement device.

The coupling arrangement may be considered as being separate from the measurement device and/or not forming part of the measurement device.

The measurement device may comprise a form of coupling which enables it to be rigidly coupled to the machine, whether via the coupling arrangement or not.

The measurement device may comprise a quick-release form of coupling (a form of coupling that allows quick and easy coupling and decoupling without the need for tools or additional equipment, e.g. a magnetic coupling) which enables it to be removably coupled to the machine, whether via the coupling arrangement or not.

The measurement device may be a fully-functional measurement device (other than perhaps power or signal processing or signal analysis).

The coupling arrangement may be adapted to receive the measurement device without any modification or adaptation to the measurement device, which measurement device can otherwise couple to the machine without the coupling arrangement in between.

An over-travel state may arise when the measurement device is moved by the machine in the direction of an object (or workpiece) in a working volume of the machine, causing the measurement device to come into contact with the object, and when the machine continues to move the measurement device in that direction, even after the contact is made, beyond a normal range of travel.

The coupling arrangement may be adapted to cause the measurement device to become at least partially decoupled from the machine when (or to change to an at least partially decoupled state from a coupled state when) a force greater than a predetermined force (or predetermined threshold) is applied to the device side of the coupling arrangement, in the predetermined direction towards (and/or transverse to) the interface.

The coupling arrangement may be adapted to cause the measurement device to become at least partially decoupled from the machine when (or to change to an at least partially decoupled state from a coupled state when) a compressive force developed in the measurement device in the predetermined direction is greater than a predetermined force (or predetermined threshold).

The above-mentioned force (or compressive force) may be caused by the measurement device being moved by the machine in the direction of, and coming into contact with, the above-mentioned object (and with the machine continuing to move the measurement device in that direction even after the contact is made).

Providing over-travel protection for the measurement device may amount to providing a range of additional relative movement between the measurement device and the machine (for example, beyond a normal range of relative movement) without causing damage to the measurement device (i.e. where the additional relative movement would otherwise cause damage to the measurement device, in the absence of the over-travel protection).

The coupling arrangement may be adapted to cause the measurement device to become at least partially decoupled from the machine when the device is moved relative to the coupling arrangement towards the interface by more than a predetermined distance and/or with more than a predetermined force (or with a force greater than a predetermined threshold). The predetermined distance/force may be a maximum distance/force expected during normal operation of the measurement device. The predetermined distance/force may be a distance/force beyond which damage may be caused to the measurement device (or at least to a part of the measurement device).

The coupling arrangement may be adapted to provide over-travel protection along a predetermined axis of the measurement device, where the predetermined axis is one or more of: a Z axis of the measurement device; a generally longitudinal axis of the measurement device; and an axis of the measurement device having the smallest available travel.

In the case of a contact measurement device, where a measurement is triggered by contact between the measurement device (for example a stylus thereof) and the object being measured, the predetermined force (or predetermined threshold) may be greater than a minimum contact force required to trigger a measurement (along the same direction, or in the predetermined direction). For example, in the case of a touch trigger measurement probe, an embodiment of the present invention effectively combines a low-force, low-travel coupling (i.e. that provided internally to the probe as part of the touch detection mechanism) with a high-force, high-travel coupling (i.e. that provided by a coupling arrangement embodying the present invention), such that the breakout (i.e. the at least partial decoupling) of the coupling arrangement occurs after the touch trigger mechanism has acted, i.e. after the measurement has been taken or recorded (but before any damage is incurred to or within the probe).

In this respect, the sequence of events might be: (a) relative movement between the measurement device and the object causes contact to be made between the measurement device and the object, though with a force still below the minimum contact force to trigger a measurement; (b) with further relative movement, the force rises above the minimum contact force, thereby triggering a measurement; (c) with further relative movement, the force rises further but is still below the predetermined force (or predetermined threshold) required to trigger the over-travel protection; and (d) with further relative movement, the force rises further, and above the predetermined force (or predetermined threshold), thereby causing the over-travel protection to become active.

The measurement device may provide a first coupling, having a first coupling force (or strength) and/or a first range of travel, with the coupling arrangement providing a second coupling, having a second coupling force (or strength) greater than the first coupling force (or strength) and/or a second range of travel greater than the first range of travel. The first coupling may be an internal coupling of the measurement device which relates to a measurement function of the measurement device. At least part of the first range of travel may correspond to a range of measurement for the measurement device. The first coupling may be associated with a sensor or transducer of the measurement device, where the sensor or transducer is for example as described above.

In this way, during normal operation a force created by contact between the measurement device and (for example) a workpiece would be sufficient to cause relative movement between the two parts of the first coupling, thereby enabling a measurement function to be performed, but insufficient to cause relative movement between the two parts of the second coupling, thereby preserving the stability and integrity of the measurement. However, increasing the force further would eventually be sufficient to overcome the second coupling, thereby providing the desired over-travel protection for the measurement device and thereby preventing damage to it.

The second coupling in this context may be that which provides over-travel protection for the measurement device. The coupling force (or strength) and range of travel in this context may be in or along the predetermined direction (e.g. from the measurement device towards the interface or vice versa) and/or along the predetermined axis of the measurement device (e.g. along the Z axis of the measurement device). The coupling force (or strength) of a coupling in this context can be considered to be the force required to break or disengage or decouple the coupling. The range of travel of a coupling in this context may also be referred to as the normal or expected or maximum range of travel for the coupling. In the case of a touch trigger probe or other such contact measurement device, the first coupling may be a coupling (such as a kinematic coupling) which couples a stylus of the measurement device to a stylus support of the measurement device.

The first coupling may be considered to provide a high-accuracy coupling, with the second coupling providing a low-accuracy coupling (or at least having an accuracy that is lower than the first coupling), with accuracy in this context relating for example to the positional accuracy or repeatability provided by the coupling.

In a case where the sensor or transducer of the measurement device cannot be said to provide a coupling as such, it will be understood that the above statements concerning the first coupling apply equivalently to a support arrangement of the measurement device that provides for relative movement between two parts of the measurement device (for example a stylus and a stylus support), with that relative movement being sensed and/or measured so as to enable the measurement function to be performed.

Accordingly, the measurement device may comprise a sensor or transducer which is adapted to sense or measure (or transduce) relative movement between two parts of the measurement device (for example a stylus and a stylus support) in order to perform a measurement function of the measurement device (for example when contact is made between the stylus and a workpiece), with the sensor or transducer being operable within a predetermined (or normal or operational or working) range of forces (or strengths) and/or a within a predetermined (or normal or operational or working) range of travel, and the coupling arrangement having a coupling force (or strength) greater than the predetermined (or normal or operational or working) range of forces (or strengths) of the sensor or transducer and/or a range of travel greater than the predetermined (or normal or operational or working) range of travel for the sensor or transducer. The range of forces (or strengths) may be in a direction towards the interface and/or along the predetermined axis of the measurement device. The coupling force (or strength) may be in a direction towards the interface and/or along the predetermined axis of the measurement device. The range of travel may be in a direction towards the interface and/or along the predetermined axis of the measurement device.

The coupling arrangement may comprise a kinematic or pseudo-kinematic coupling for coupling the coupling arrangement to the coordinate positioning machine. This would make the coupling arrangement suitable for use in an autochange system, for example.

Over-travel protection may amount to at least 10% of a representative dimension or length of the device in the direction of over-travel (or predetermined direction), preferably at least 15% and more preferably at least 25% and more preferably at least 50%.

Over-travel protection may amount to at least 10 mm in the direction of over-travel (or predetermined direction), preferably at least 20 mm and more preferably at least 30 mm and more preferably at least 50 mm.

The measurement device may have a normal mounting direction and the coupling arrangement may be adapted to reverse the mounting direction of the measurement device compared to normal. The normal mounting direction may be a direction from a working part of the measurement device, such as a stylus tip of a measurement probe, to a mounting part, for example along a generally longitudinal axis of the measurement device.

In this way, the coupling arrangement may be considered as being an adaptor, with a combination of the measurement device and the adaptor coupling to and uncoupling from the machine in a generally reverse direction compared to normal.

The coupling arrangement may be considered as being an adaptor for changing the nature of the coupling which would otherwise be present (so as to provide over-travel protection for the device).

The interface between the device and the coupling arrangement may be where the device is mounted or coupled to the coupling arrangement.

The machine may be or comprise a non-Cartesian machine.

The machine may be or comprise a parallel kinematic machine.

The machine may be or comprise a serial kinematic machine.

The machine may be or comprise a serial kinematic machine having a plurality of segments connected in series via rotary joints.

The machine may be or comprise a robot arm.

The measurement device may be some type of tool or instrument other than a measurement device.

The coordinate positioning machine may be some type of machine other than a coordinate positioning machine.

According to a second aspect of the present invention, there is provided a kit comprising a measurement device and a coupling arrangement according to the first aspect of the present invention.

According to a third aspect of the present invention, there is provided a coordinate positioning machine comprising a measurement device coupled to the machine via (and/or or using) a coupling arrangement according to the first aspect of the present invention. The coupling arrangement may be provided between the machine and the measurement device.

The coordinate positioning machine may comprise a moveable support member and the measurement device may be coupled to the moveable support member via the coupling arrangement. The coupling arrangement may be coupled to the moveable support member via a kinematic or pseudo-kinematic coupling (for example as part of an autochange system).

The coordinate positioning machine may be a robot arm. The moveable support member may be an end effector of the robot arm.

The coordinate positioning machine may be a hexapod machine. The moveable support member may be a moveable platform of the hexapod machine.

According to a fourth aspect of the present invention, there is provided a method of coupling a measurement device to a coordinate positioning machine, comprising coupling the device to a moveable support member of the machine via a coupling arrangement according to the first aspect of the present invention. The coupling arrangement may be provided between the machine and the measurement device.

Reference will now be made, by way of example, to the accompanying drawings, in which:

FIG. 1, discussed hereinbefore, is a schematic illustration of a coordinate positioning arm in the form of an articulated robot;

FIG. 2, also discussed hereinbefore, is a schematic illustration of an articulated robot having a different arrangement of rotary axes to that of FIG. 1;

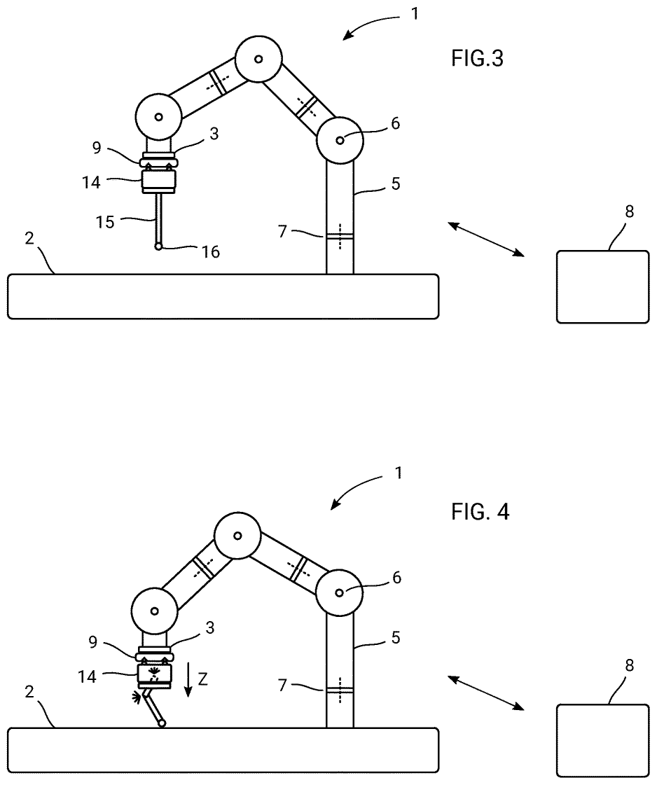

FIG. 3 is a schematic illustration of a measurement probe coupled to an articulated robot of a type shown in FIG. 1;

FIG. 4 is for use in explaining a problem associated with the form of coupling used in FIG. 3 to couple the measurement probe to the articulated robot;

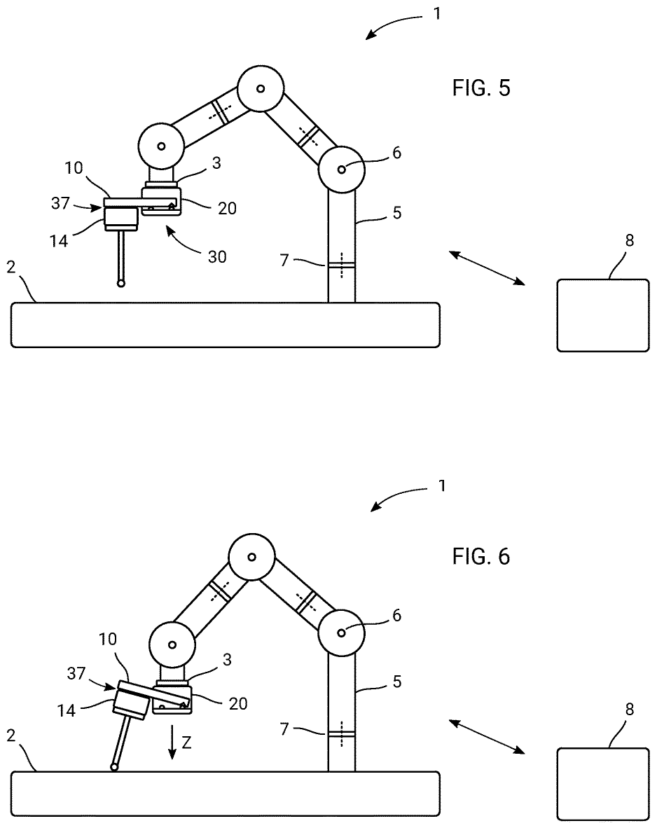

FIG. 5 is a schematic illustration of a coupling arrangement embodying the present invention being used to couple the measurement probe to the articulated robot;

FIG. 6 shows how the coupling arrangement of FIG. 5 provides over-travel protection for the measurement probe in a situation equivalent to that of FIG. 4;

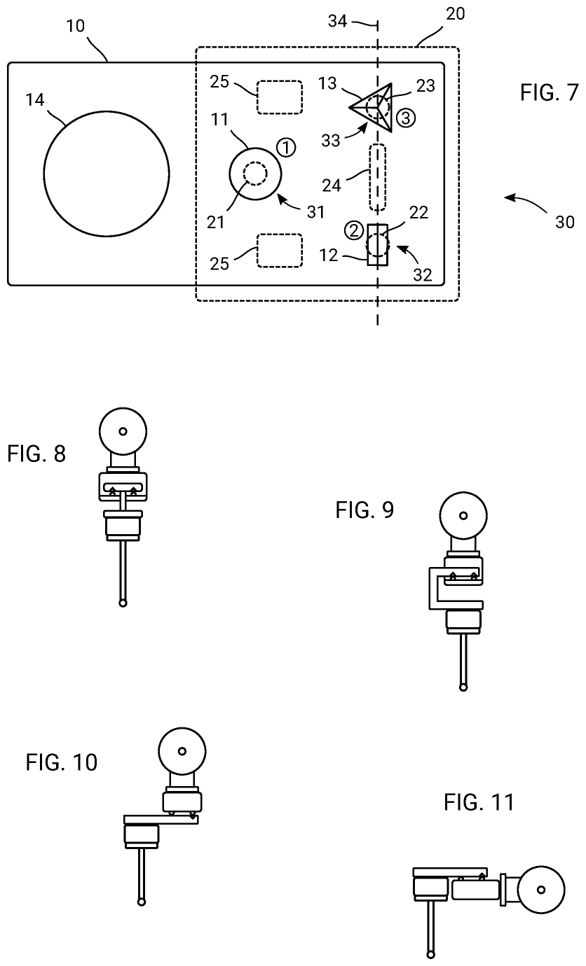

FIG. 7 shows a plan view of how the two halves of a coupling arrangement of a type shown in FIG. 5 interact and couple to one another;

FIG. 8 is a schematic illustration of an alternative form of coupling arrangement to that of FIG. 5, with the coupled measurement probe being more in line with the flange rather than offset;

FIG. 9 shows a slight variation of the coupling arrangement of FIG. 8;

FIG. 10 is a schematic illustration of an alternative form of coupling arrangement embodying the present invention, in which the measurement probe couples to the flange in an upward direction but is offset therefrom;

FIG. 11 is a schematic illustration of a coupling arrangement similar to that shown in FIG. 5 but with the articulated robot being mounted to the coupling arrangement from the side;

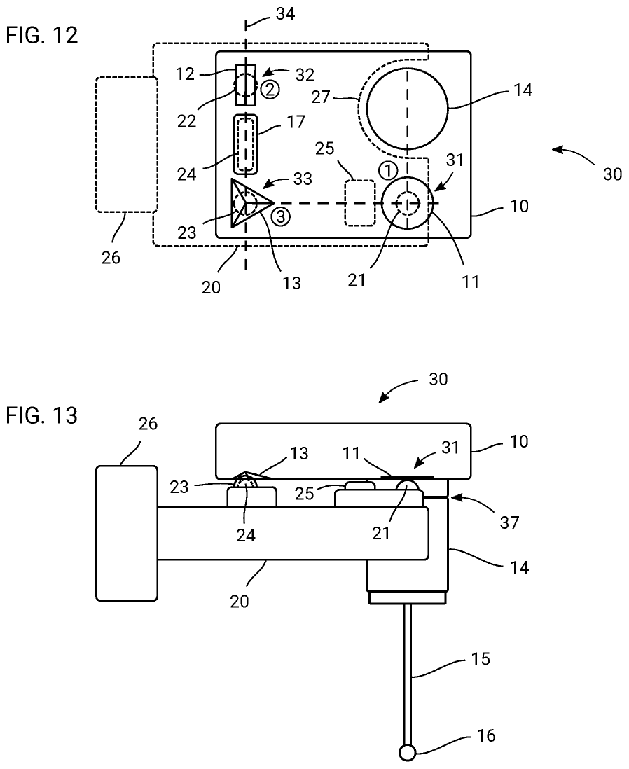

FIG. 12 shows a plan view of how the two halves of a coupling arrangement of a type shown in FIG. 11 interact and couple to one another, similar to the view shown in FIG. 7;

FIG. 13 shows a side view of the coupling arrangement of FIG. 12, when in a coupled state;

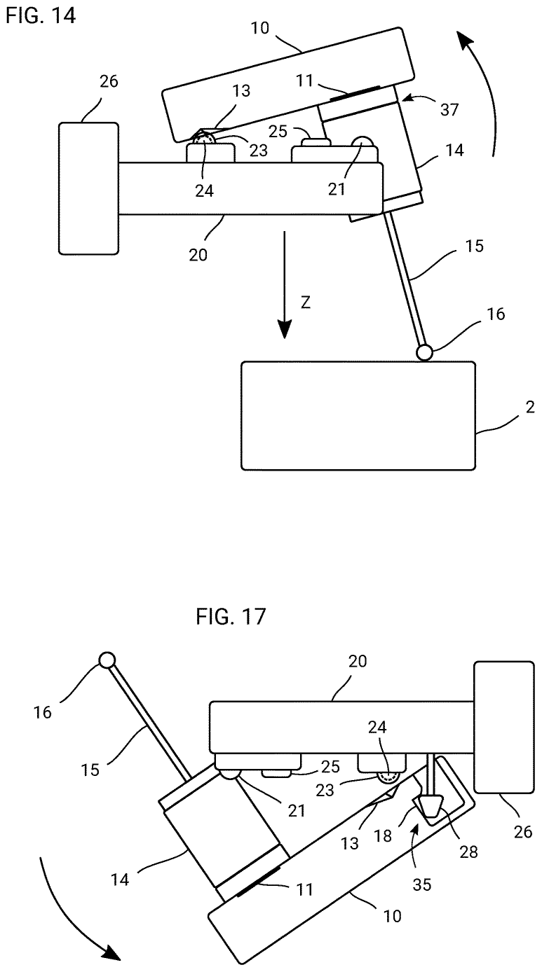

FIG. 14 shows a side view of the coupling arrangement of FIG. 12, when in a partially decoupled or partially coupled state, thereby providing over-travel protection for the measurement probe;

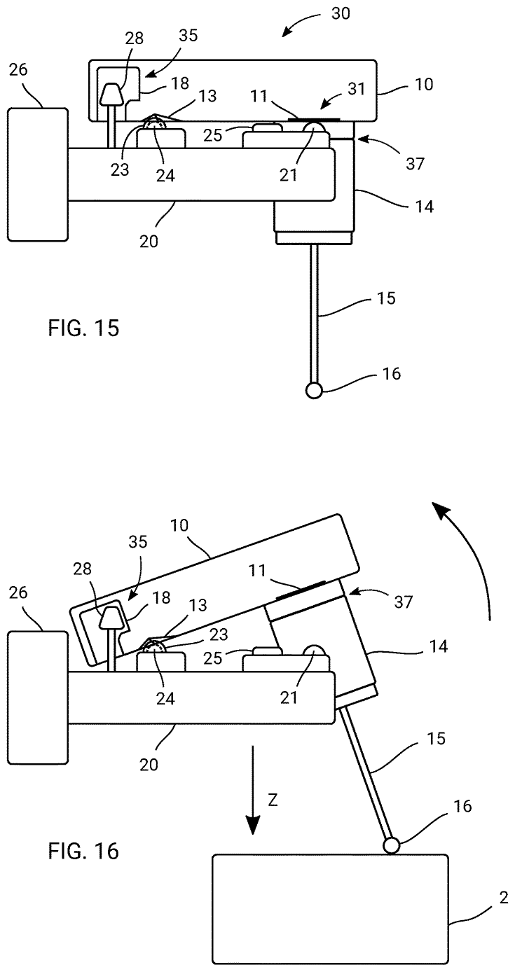

FIG. 15 shows a side view of a coupling arrangement based on that of FIG. 13 but modified to include a retaining mechanism;

FIG. 16 shows side view of the coupling arrangement of FIG. 15 equivalent to that shown in FIG. 14 but showing operation of the retaining mechanism when in the partially decoupled or partially coupled state;

FIG. 17 shows operation of the retaining mechanism of the coupling arrangement of FIG. 15 when the measurement probe is upside down and when the coupling arrangement is in a partially decoupled or partially coupled state;

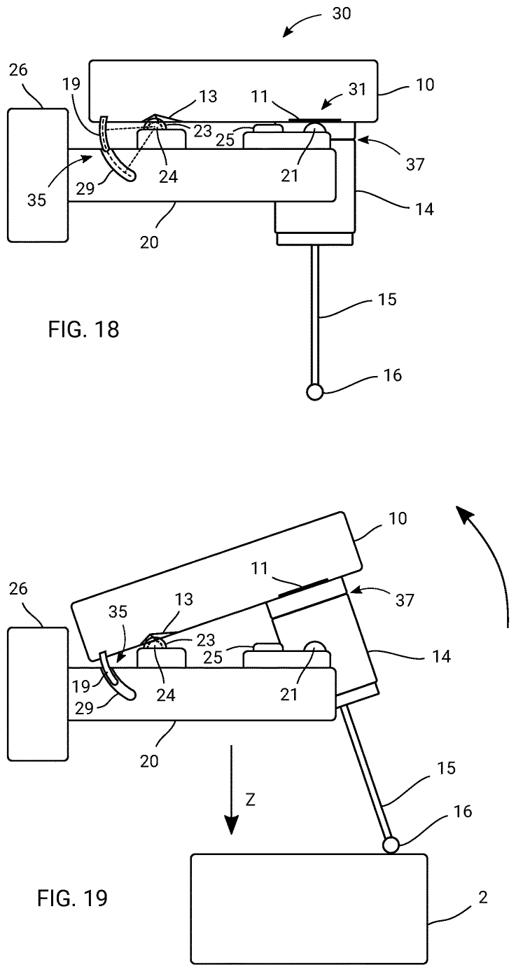

FIG. 18 shows a side view of a coupling arrangement based on that of FIG. 16 but with a different form of retaining mechanism;

FIG. 19 shows side view of the coupling arrangement of FIG. 18 showing operation of the retaining mechanism when in the partially decoupled or partially coupled state;

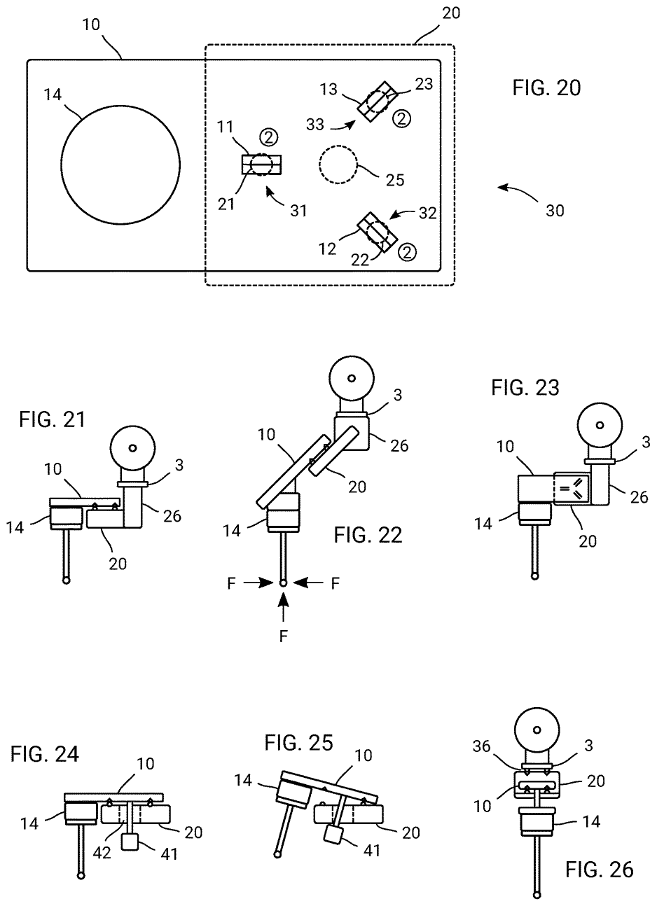

FIG. 20 illustrates a coupling arrangement embodying the present invention that is based on a “2-2-2” configuration instead of a “1-2-3” configuration;

FIG. 21 is a schematic illustration showing one way in which a measurement probe can be coupled to a robot arm using the coupling arrangement of FIG. 20;

FIG. 22 is a schematic illustration showing another way in which a measurement probe can be coupled to a robot arm using the coupling arrangement of FIG. 20;

FIG. 23 is a schematic illustration showing yet another way in which a measurement probe can be coupled to a robot arm using the coupling arrangement of FIG. 20;

FIG. 24 is a schematic illustration of a retaining mechanism for the coupling arrangement of FIG. 20, with the coupling arrangement being shown in the seated position;

FIG. 25 illustrates schematically how the retaining mechanism of FIG. 24 acts to prevent a complete separation of the two halves of the coupling arrangement; and

FIG. 26 is a schematic illustration of a variation of the arrangement shown in FIG. 8, in which an additional kinematic is provided between the coupling arrangement and the robot arm.

FIG. 3 is a schematic illustration of a measurement probe 14 coupled to an articulated robot 1 of a type described previously with reference to FIG. 1. The measurement probe 14 in this example is a touch trigger measurement probe having a workpiece-contacting stylus 15 terminated in a stylus tip 16. Such measurement probes are well known, and a detailed description is not required, although measurement probes are not typically used in combination with an articulated robot for measurement tasks, for the reasons explained above. The measurement probe 14 is coupled to the flange 3 of the robot arm 1 in this example via a kinematic (or at least pseudo kinematic) coupling arrangement 9, with the coupling arrangement 9 being rigidly mounted to the flange 3.

The present applicant has appreciated that, when the robot arm 1 is being controlled to perform various measurement tasks using the measurement probe 14, there is a risk that the measurement probe 14 may inadvertently be driven beyond its normal range of travel. An example of this is shown in FIG. 4, where the measurement probe 14 has been driven too far in a Z direction into the fixed base 2, not only causing the stylus 15 to snap but also causing the stylus 15 to transfer excessive forces into the body of the measurement probe 14, causing internal damage as well. This over-travel may result from errors in the current machine parameters (so that the end of the robot arm 1, and hence the stylus tip 16 of the measurement probe 14, is not where it is expected to be), or from errors in programming the robot controller 8 for a measurement routine, or from human error when manually controlling the robot arm 1 using e.g. a joystick controller (whether or not as part of the measurement routine), or from a combination of these.

Trying to force the measurement probe 14 beyond its normal range of travel, which is typically very small as described in more detail below and does not account for errors of the type described above, is likely to lead to damage being caused to the measurement probe 14 (not only to the stylus 15 but also to delicate internal mechanisms of the measurement probe 14), requiring expensive replacement and/or repair of the measurement probe 14. More significantly perhaps, this may also result in disruption and delay to measurement and production procedures in the facility in which the measurement probe 14 is being used. Accordingly, the present applicant has appreciated the desirability of producing a system that is more resilient to such adverse events as described above that will inevitably occur in practice and that may result in damage to the measurement probe 14, particularly when attached to a robot arm 1.

With the above context in mind, FIG. 5 shows a robot arm 1 that is that same as that described above with reference to FIG. 3, having a plurality of segments 5 connected by a combination of transverse rotary axes 6 and inline rotary axes 7. However, in FIG. 5 the measurement probe 14 is coupled to the flange 3 of the robot arm 1 via a coupling arrangement 30 embodying the present invention. The coupling arrangement 30 is provided between the measurement probe 14 and the flange 3 of the robot arm 1, in place of the coupling arrangement 9 of FIGS. 3 and 4. The coupling arrangement 30 is mounted rigidly to the flange 3, and in this example the measurement probe 14 is mounted rigidly to part 10 of the coupling arrangement, for example via a screw thread connection.

The coupling arrangement 30 is specifically adapted to provide over-travel protection for the measurement probe 14. In particular, in this example, the coupling arrangement 30 is adapted to decouple the measurement probe 14 at least partially from the flange 3 of the robot arm 1 when the measurement probe 14 is moved (more than is desirable) relative to the coupling arrangement 30 in a predetermined direction towards an interface 37 therebetween, thereby providing over-travel protection for the measurement probe 14 by allowing additional relative movement in that direction without causing damage to the measurement probe 14.

This is illustrated schematically in FIG. 6, in which the measurement probe 14 has been driven vertically in the Z direction more than is intended, and into the fixed bed 2. Rather than cause damage as shown in FIG. 4, and as will be explained in further detail below, the two parts 10 and 20 of the coupling arrangement 30 become unseated from one another (at least partially), and in doing so this allows an additional range of travel in this direction without any damage being done to the measurement probe 14 itself.

The measurement probe 14 would typically inherently allow a very small amount of travel in this direction after contact with the bed 2, but only sufficient to register the contact and to account for a normal and expected stopping distance for the machine to which it is coupled. In this respect, the measurement probe 14 would comprise a sensor or transducer which is adapted to convert a physical stimulus (in this example, contact between the stylus tip 16 and the bed 2) into an electrical signal (in this example, a touch trigger signal), preferably in all directions including the Z direction (where the Z direction is along the generally longitudinal axis of the measurement probe 14, i.e. in the probe frame of reference rather than machine frame of reference). This transduction may work, for example, by the breaking of internal electrical contacts or by the flexing of internal structures that have strain gauges attached, both of which rely on at least a small amount of relative movement. In other words, the measurement probe 14 is a fully functional measurement device of itself and not just part of a measurement device. Note that the measurement probe 14 may itself be modular in nature, such as in the TP20 and TP200 probing systems from Renishaw plc in which a common probe body (which is mounted to the machine) can couple to any of a number of different probe modules (also referred to as stylus modules) which have different properties or responses, which in turn can hold any of a number of different styli which have different lengths or configurations. Each probe module of the TP20/TP200 probing system houses a kinematic switching touch sensor mechanism, and also carries a stylus assembly for coupling to a stylus. The measurement device in this context would be considered to be a combination of the probe body, probe module and stylus, or at least a combination of the probe module and stylus, or at the very least the probe module. In particular, the stylus would not be considered in this context to be a measurement device because it is not adapted (of itself) to measure anything; for example, it does not have any sensor or transducer which is adapted to convert a physical stimulus (e.g. a deflection caused by a touch) into an electrical signal. Conversely it can be said that a coupling arrangement embodying the present invention does not provide (and/or is not intended to provide) any measurement-related functionality for the measurement device which it is coupling to the coordinate positioning machine, but only a coupling functionality (with over-travel protection).

Furthermore, the coupling arrangement 30 is advantageously adapted to receive the measurement probe 14 without any adaptation being required to the measurement probe 14 itself. For example, the measurement probe 14 is able to couple to the flange 3 of the robot arm 1 with or without the coupling arrangement 30 being provided in between. The measurement probe 14 would typically have a quick-release form of coupling, i.e. a form of coupling that allows quick and easy coupling and decoupling without the need for any special tools or equipment. For example, the measurement probe 14 might have a magnetic form of quick-release coupling (for example the magnetic kinematic mounting between the probe body and the probe module of the TP20/TP200 probing system mentioned above) or it might have a screw-thread form of quick-release coupling (for example as per the LP2 modular probe system from Renishaw plc, which can also integrate with the OMP40 and OMP60 modular systems also from Renishaw plc, or the TP20/TP200 probing system mentioned above where the probe body has a screw thread connection to the machine). The same measurement probe 14 can therefore be used on a three-axis coordinate measuring machine having a conventional coupling arrangement, or on a robot arm as shown in FIG. 5 via a coupling arrangement 30 embodying the present invention, or the measurement probe 14 can be mounted directly to the robot arm 1 as shown in FIG. 3 without any over-travel protection. This flexibility and ease-of-use is a significant advantage of a coupling arrangement 30 embodying the present invention, since it can be used as and when required in conjunction with an existing probe system.

In brief, the coupling arrangement 30 comprises two parts 10 and 20 coupled together via a kinematic (or at least pseudo kinematic) coupling, in a reverse configuration compared to the sort of coupling arrangement 9 shown in FIG. 3, and accordingly can be referred to as a reverse kinematic arrangement. A kinematic coupling is by its nature very repeatable, which is advantageous because the two parts 10 and 20 of the coupling arrangement 30 can uncouple (to protect the measurement probe 14 from damage) and then recouple in precisely the same relative orientation, i.e. as if nothing had happened.

The coupling arrangement 30 of FIG. 5 can be said to be in a reverse configuration compared to that of FIG. 3 because the measurement probe 14 of FIG. 5 couples to the flange 3 in a downward direction, despite being located below the flange 3. This is achieved by arranging for part 10 to sit above part 20 when coupled. Compare this to the coupling arrangement 9 of FIG. 3, in which the measurement probe 14 couples to the flange 3 in an upward direction. Because the coupling arrangement 30 of FIG. 5 is reversed compared to the coupling arrangement 9 of FIG. 3, the coupling arrangement 30 of FIG. 5 will cause the measurement probe 14 to become decoupled if it is pushed with excessive force towards the flange 3, whereas with the coupling arrangement 9 of FIG. 3 this would not occur and instead the measurement probe 14 would be subject to excessive (and potentially damaging) compressive forces. In other words, the coupling arrangement 30 of FIG. 5 will tend to decouple when the two parts 10, 20 are pushed towards each other, rather than when they are pulled away from each other (which would be the case for the coupling arrangement 9 of FIG. 3).

A more detailed example of how these two parts 10 and 20 interact and couple to one another is shown in FIG. 7. The measurement probe 14 is mounted to part 10, with the other part 20 being mounted to the robot arm 1 via the flange 3. Kinematic features 11, 12, 13 are provided on the underside of part 10 (according to the orientation shown in FIGS. 5 and 6). A first (flat) feature 11 at a first location 31 provides a single point of contact with a corresponding ball 21 on the other part 20 of the coupling arrangement 30, a second (v-groove) feature 12 at a second location 32 provides two points of contact with a corresponding ball 22 on the other part 20 of the coupling arrangement 30, and a third (tetrahedral) feature 13 at a third location 33 provides two points of contact with a corresponding ball 23 on the other part 20 of the coupling arrangement 30.

The coupling arrangement 30 is thereby adapted to provide a kinematic or pseudo-kinematic coupling between the measurement probe 14 and the robot arm 1, defining six points of contact over three locations 31, 32, 33 in a “1-2-3” arrangement (with one point of contact at the first location 31, two points of contact at the second location 32, and three points of contact at the third location 33, hence referred to as a “1-2-3” arrangement; the three elements of the “1-2-3” configuration are denoted in FIG. 7 by circled numbers 1, 2 and 3 respectively). The six points of contact constrain the measurement probe 14 and the robot arm 1 in six degrees of freedom (though in practice these are not points in a mathematical sense, but small areas that approximate points).

In the context of locating a body relative to another, kinematic design considerations are met by constraining the degrees of freedom of motion of the body using the minimum number of constraints, and in particular involves avoiding over constraining. Over constraining can result in multiple points of contact between two bodies enabling one body to rest in more than one position against the other. Accordingly, the body's location is not repeatable as it is not known at which of the several positions the body will come to rest. In particular, where there is over constraint, there is a conflict between the constraints that are in place, so that it is not possible to determine with any certainty which combination of constraints will determine the actual position of the body. These concepts are described in H. J. J. Braddick, “Mechanical Design of Laboratory Apparatus”, Chapman & Hall, London, 1960, pages 11-30, and James G. Skakoon, “Exact constraint”, Mechanical Engineering, September 2009.

The two parts 10, 20 of the coupling arrangement 30 are held together magnetically by magnets 24, 25 on part 20, with part 10 being formed of magnetic material (or at least those parts closest to magnets 24, 25) and therefore being attracted magnetically by magnets 24, 25. However, when the measurement probe 14 is pushed with a force which is sufficient to overcome the magnetic bias force from the magnets 25 located either side of the first location 31, the magnetic coupling between the parts 10, 20 is broken at the first location 31 (i.e. at the location that provides a single one of the six constraints to relative motion between the two parts 10, 20), but not at the second and third locations 32, 33 (i.e. at the locations that provide the other five constraints to relative motion), such that the coupling is only partially broken.

By losing a single constraint, which in this example is a constraint to relative rotational movement, this provides a single degree of freedom for relative movement between the two parts 10, 20, which in this example is a rotational degree of freedom around the axis 34. In other words, the two parts 10, 20 become uncoupled in one degree of freedom but remain coupled in five degrees of freedom. Advantageously, magnet 24 is cylindrical in form, with the axis of the cylinder being arranged coincident with the axis 34 between the two balls 22, 23 (at locations 32, 33), and this allows part 10 to pivot around the axis 34 relative to part 20 while maintaining a substantially constant magnetic force of attraction between parts 10, 20 as the pivoting occurs. This pivoting action will also be apparent from the discussion below with reference to the embodiment shown in FIGS. 12 to 14. It should also be noted that the cylindrical magnet 24 could instead be a cylindrical target formed of magnetic material, with the magnet itself being on part 10, i.e. with the magnetic coupling reversed, and similarly the magnetic coupling formed by magnet 25 could also be reversed.

Because the decoupling is only partial, the two parts 10, 20 remain attached to some extent and the measurement probe 14 accordingly also remains attached and does not fall off (thereby causing damage). An additional retaining feature can be provided to make it more difficult for the two parts 10, 20 to become completely separated, for example requiring them to be re-aligned parallel to one another before being separated, and this possibility will be discussed in more detail below with reference to FIGS. 15 to 19.

It is to be noted that, in general terms, a kinematic coupling used in a coupling arrangement embodying the present invention is not limited to a “1-2-3” configuration as described above. For example, a kinematic coupling can also be formed by three rotationally symmetric v-grooves in a “2-2-2” configuration, having in common that exactly six points of contact are provided in order to provide exact constraint in all six degrees of freedom. However, a “1-2-3” arrangement is preferable in the embodiment shown in FIG. 7, because it enables the creation of a pivot axis by the loss of only one constraint as described above. This is advantageous because of the manner in which partial decoupling occurs, or perhaps more importantly because of the manner in which it leads to a proper recoupling taking place following a partial decoupling or over-travel event.

In this respect, when the coupling is broken at one of the three locations with a “2-2-2” configuration, there would be a loss of two constraints (corresponding to the creation of two degrees of freedom) because each location provides two constraints to relative motion between the two parts 10, 20. This would mean that the two parts 10, 20 remain constrained in only four degrees of freedom (rather than five), and would enable not only pivoting around an axis defined between the two remaining locations (like the axis 34 described above), but also around a second axis that is normal to the plane containing the three locations. The disadvantage of this is that the two parts 10, 20 might not return to the same relative position and orientation when they come together again, because the kinematic features at the first location may no longer be aligned due to the additional rotation around the second axis.

On the other hand, with only a single axis of rotation, created by the loss of only one constraint in a “1-2-3” configuration, the only possibility is that the two parts 10, 20 come together again with the kinematic features at the first location 31 still aligned, thereby recoupling in a kinematic fashion and repeatable fashion with the relative position and orientation of parts 10, 20 unchanged. This is because movement is only possible along (or around) a single axis, and there can be no deviation from that axis so that it will always return to the same location along (or around) that axis; it is effectively like motion along a single “track”. It will be appreciated that an alternative coupling arrangement could be devised in which a single linear constraint is broken, rather than a single rotational constraint, so that one part 10 will translate relative to the other part 20 rather than rotate or pivot.

Rather than the offset type of coupling arrangement 30 shown in FIGS. 5 to 7, a more in-line coupling arrangement can be provided, as shown for example in FIGS. 8 and 9. Furthermore, a reverse kinematic type of arrangement is not essential to achieve the intended effect, and instead this can be achieved as shown in FIG. 10 where the measurement probe 14 is offset from the flange 3, so that it will tend to pivot off (become decoupled) when the measurement probe 14 is moved towards the interface between the measurement probe 14 and the coupling arrangement 30 even though not strictly in a reverse configuration (i.e. the measurement probe 14 couples to the flange 3 via the coupling arrangement 30 in an upward direction, just like it does in FIG. 3).

FIG. 11 shows a side-mounted arrangement in schematic form, with a normal to the flange 3 of the robot arm 1 being normal to a longitudinal axis of the measurement probe 14 unlike the arrangement of FIG. 5 where the normal to the flange 3 of the robot arm 1 is parallel to the longitudinal axis of the measurement probe 14. An embodiment of this sort of arrangement will now be described in more detail with reference to FIGS. 12 to 14.

The coupling arrangement 30 shown in plan view in FIG. 12 is generally similar to that shown in FIG. 7, so that a detailed description is not required, with some changes to the relative locations of the kinematic features 11, 12, 13 of part 10 and corresponding kinematic features 21, 22, 23 of part 20. This allows a more compact arrangement overall, with the measurement probe 14 mounted alongside the first (flat) kinematic feature 11 at location 31, and with a cut-out 27 provided in part 20 to accommodate this. A mounting plate 26 is provided in conjunction with the part 20, with the mounting plate 26 being adapted for mounting to the flange 3 of the robot arm 1. A recess 17 is also provided in part 10, corresponding in location to the cylindrical magnet 24, such that the cylindrical magnet 24 protrudes partially into the recess 17 thereby enabling parts 10 and 20 to sit more closely together and with a higher magnetic bias force.

FIG. 13 shows a side view of the coupling arrangement 30 of FIG. 12, in a fully coupled state, also showing an interface 37 between the measurement probe 14 and the coupling arrangement 30 (specifically, in this example, part 10 of the coupling arrangement 30). In this respect, it is movement of the measurement probe 14 relative to the robot arm 1 in a direction towards the interface 37 that causes the measurement probe 14 to become partially decoupled from the robot arm 1. Or, conversely, it is movement of the robot arm 1 (specifically, in this example, the flange 3 of the robot arm 1) relative to the measurement probe 14 in the opposite direction that causes the partial decoupling.

When the stylus tip 16 comes into contact with the fixed bed 2 (or any other object such as a workpiece) in the vertical or Z direction the measurement probe 14 will trigger a measurement initially, through movement in a normal range of travel provided for in this direction, but if the flange 3 of the robot arm 1 is inadvertently driven further in this direction, then a compressive force will develop in the measurement probe 14 which will eventually be sufficient to break the magnetic coupling provided by magnet 25 provided alongside the first location 31. The strength of this magnet 25 is chosen so as to ensure that the coupling is broken at the first location 31 before sufficient compressive force has developed in the measurement probe 14 to cause damage. Conversely, the strength of the magnet 25 is also chosen so as to ensure that the coupling is not broken at the first location 31 before a measurement is triggered by the measurement probe 14; in other words, the biasing force provided by the magnet 25 in the Z direction is arranged to be greater than a minimum contact force required to trigger a measurement in the Z direction by the measurement probe 14. This allows the measurement probe 14 to function normally, with measurements being triggered as per normal in all directions X, Y and Z, whilst also protecting the measurement probe 14 against over-travel in the Z direction.

As shown in FIG. 14, the two parts 10 and 20 of the coupling arrangement 30 become decoupled at the first location 31 (defined by features 11, 21) but remain coupled at, and pivot around, the second and third locations 32, 33 (defined respectively by features 12, 22 and 13, 23), similar to what was discussed above with reference to the embodiment of FIG. 7. Part 10 pivots or rotates around the axis 34 created between the second and third locations, and because the cylindrical magnet 24 is arranged along the axis 34, the magnetic coupling strength remains substantially constant during the pivoting. FIG. 14 shows the coupling arrangement 30 in a partially decoupled (or over-travel) state, compared to the coupled state shown in FIG. 13. The coupling arrangement 30 has thereby provided over-travel protection for the measurement probe 14, allowing additional relative movement in the Z direction (or along the generally longitudinal axis of the measurement probe 14) without any damage being done.

If the robot arm 1 is now controlled to move the measurement probe 14 away from the fixed bed 2 again, so that the over-travel condition is removed, the two parts 10, 20 of the coupling arrangement 30 will pivot back towards each other and will become recoupled again and held magnetically to each other. Because the coupling was broken at location 31, and thereby effectively losing only one constraint to relative motion, as described above with reference to FIG. 7 it is ensured that the parts 10, 20 will recouple with the kinematic features aligned at all locations 31, 32, 33 because there is relative movement only along (or around) a single axis. What is more, because of the beneficial nature and properties of a kinematic coupling, the two parts 10, 20 (and therefore also the measurement probe 14 and the flange 3) will recouple in precisely the same relative orientation as before they became uncoupled. In other words, the relative position between these parts is repeatable, such that the measurement probe 14 can become uncoupled from the robot arm 1 and recouple multiple times, and it will always recouple to the robot arm 1 in the same (repeatable) relative position.

On the other hand, further movement in the same direction from the partially coupled state shown in FIG. 14 may cause the coupling to break even at the second and third locations 32, 33, in which case the coupling arrangement 30 is then in a completely decoupled state. Accordingly, the measurement probe 14 may become completely detached from the robot arm 1 and may therefore incur damage if it then falls away from the robot arm 1 onto the floor. A retaining (or catch or retention or detent) mechanism which addresses this situation will now be described with reference to FIGS. 15 and 16.

The coupling arrangement 30 shown in FIG. 15 is generally the same as that shown in FIG. 13, so that a detailed description is not required. The only difference is that the coupling arrangement 30 of FIG. 15 is provided with a retaining mechanism 35, which comprises a post 28 fixed rigidly to part 20 and a shaped recess 18 formed within part 10. FIGS. 15 and 16 show the coupling arrangement 30 in the same coupling state as FIGS. 13 and 14 respectively, i.e. FIG. 15 illustrates a fully coupled state while FIG. 16 illustrates a partially decoupled (or partially coupled) state.

The recess 18 is configured to receive the post 28 when parts 10 and 20 of the coupling arrangement 30 are substantially parallel to one another, as shown in FIG. 15, which enables the coupling arrangement 30 to be coupled and decoupled in this way. The recess 18 and post 28 are also mutually configured such that, when part 10 is pivoted away from part 20 as shown in FIG. 16, an enlarged portion of the post 28 is received into a side portion of the recess 18 and over a protruding part of the recess 18. In order to become completely decoupled, part 10 must become decoupled from part 20 at locations 32 and 33 (having already become decoupled at location 31). But, in the state shown in FIG. 16 this is no longer possible because the retaining mechanism 35 acts to prevent part 10 being lifted away from part 20 to break the coupling at these locations, and in this implementation also acts as a stop to prevent part 10 being pivoted further away from part 20.

Not only does this prevent part 10 from coming away completely from part 20, thereby preventing the measurement probe 14 falling off the robot arm 1 and potentially incurring damage when it falls to the floor, but it also means that the only way in which part 10 can move is to pivot back towards part 20 around the only degree of freedom available to it, i.e. rotation around axis 34, so that it will again become coupled correctly as shown in FIG. 15. Furthermore, because of the repeatable nature of the kinematic coupling described above, the measurement probe 14 will recouple to the robot arm 1 in exactly the same relative position and orientation as it was before becoming at least partially decoupled (i.e. the relative position and orientation is repeatable). The measurement probe 14 can decouple and recouple many times, not only without falling off but also without any recalibration being required in order to determine again where the stylus tip 16 of the measurement probe 14 is located relative to the flange 13 of the robot arm 1.

When in a partially decoupled (or over-travel) state as shown in FIG. 16, part 10 and the attached measurement probe 14 will naturally fall under gravity once the over-travel condition is removed, i.e. once the stylus tip 16 is moved away from the bed 2 (or other object such as a workpiece), and will therefore not naturally fall off completely and will instead become fully recoupled as shown in FIG. 15. The use of a retaining mechanism 35 is particularly advantageous to prevent the measurement probe 14 from falling off completely in a situation where the robot arm 1 has rotated the coupling arrangement 30 (and measurement probe 14) such that it is upside down in the working volume, for example in order to measure the lower surface of a workpiece or inside a bore accessible only from below, and then becomes partially decoupled for over-travel protection by operation of the coupling arrangement 30. In this scenario, the part 10 and the attached measurement probe 14 will naturally fall under gravity but will be prevented from coming off completely by the retaining mechanism 35, and in the worst case will merely end up hanging from the part 20 that is mounted to the robot arm 1 in a state as shown in FIG. 17 (which can be considered to be a fully decoupled state, though still attached via the retaining mechanism 35). In order to recouple the measurement probe 14 to the robot arm 1, either the operator can manually push the part 10 upwards until it re-engages with part 20, or the robot arm 1 can be controlled to rotate the coupling arrangement 30 (and measurement probe 14) back around, with the constraints provided by the retaining mechanism 35 (along with gravity) first causing the parts 10, 20 to recouple at locations 32, 33 as shown in FIG. 16, thereby forming the rotational axis 34 again, and then with gravity causing the parts 10, 20 to pivot back to the fully coupled state shown in FIG. 15.

It will be noted that there a clearance is provided between the post 28 and the walls of the recess 18, at least when in the fully coupled state shown in FIG. 15, so that there is no contact between these two parts. If contact were made, this would create extra constraints between parts 10 and 20, and this in turn would create over constraint between these parts which is undesirable for the reasons explained above. It is preferable to retain a pure kinematic coupling, with exactly six points of contact and six corresponding constraints (one for each of the six degrees of freedom). Accordingly, the presence of the retaining mechanism 35 does not therefore interfere with the kinematic nature of the coupling in the fully coupled state. It is also preferable that clearance is maintained even in the partially coupled state, when pivoting around the axis 34, in order to preserve the purity of the axis 34 rather than create extra constraints in the retaining mechanism 35 that which will tend to fight against the five remaining constraints created at locations 32, 33, and also create some uncertainty in the position and orientation of axis 34 (as well as extra friction).

It will be appreciated that other forms of retaining mechanism could be used, and just one other example is illustrated in FIGS. 18 and 19. The retaining mechanism 35 of this example comprises a curved bar 19 attached rigidly to an outer side surface of part 10 which is moveable along a corresponding curved groove or track 29 machined into an outer side surface of part 20, both having a curve that is part-circular and concentric with the pivot axis 35 defined between kinematic locations 32 and 33. As can be seen in FIG. 19, when part 10 pivots away from part 20 around the axis 35 referred to above, the curved bar 19 will move into and around the curved groove 29. This will act as a “hook” that will prevent part 10 coming away from part 20, and so that part 10 remains pivotally or rotatably coupled to part 20 via the axis 35. The only way in which the curved bar 19 can be extracted from the curved groove 29 is to rotate part 10 back towards part 20 around axis 35, because part 10 cannot be moved linearly away from part 20 due to the action of the mutually cooperating (and curved) parts of the retaining mechanism 35. Again, there should ideally be clearance between the bar 19 and the groove 29, at least when in the fully coupled state shown in FIG. 18 but preferably also in the partially decoupled (or over-travel) state shown in FIG. 19.

It will be noted that some other form of retaining mechanism could be used, other than those examples shown FIGS. 15 to 19. The examples provided herein are relatively simple to implement, though still effective, but a more sophisticated form of retaining mechanism could be used instead. For example, an active retaining mechanism rather than a passive retaining mechanism could be employed.

It was mentioned above that an embodiment of the present invention can be based on a kinematic coupling having a “2-2-2” configuration instead of a “1-2-3” configuration, and such an embodiment is illustrated in FIG. 20. The coupling arrangement 30 shown in FIG. 20 is generally similar to that shown in FIG. 7, so that a detailed description is not required. The main difference is that each of the kinematic features 11, 12, 13 is a v-groove which provides two of the six points of contact (hence being referred to as a “2-2-2” configuration), thereby providing exact constraint in all six degrees of freedom.

FIGS. 21 and 22 show two (of many) different ways in which the coupling arrangement 30 of FIG. 20 (or indeed any coupling arrangement embodying the present invention) can be arranged to provide over-travel protection for a measurement probe 14 (or other type of measurement device) supported on a robot arm 1 (or other type of coordinate positioning machine). The arrangement shown in FIG. 21 is generally similar to that shown in FIG. 11, though with the coupling arrangement being attached to the flange at right angles compared to FIG. 11. The angled arrangement shown in FIG. 22 can be useful in some situations because it can offer improved protection against a knock from the side, or equivalently against a move in the Z direction into a surface that is inclined at an angle and such that the stylus experiences an excessive force both in the Z direction and in a X or Y (i.e. lateral) direction, because a pivoting motion will be created which will cause the two halves of the coupling to become unseated from one another. In this respect, some degree of overtravel protection would be provided for the arrangement of FIG. 22 against a knock in any of the directions shown by the arrows.

It will be appreciated that the measurement probe (or other type of measurement device) can also be mounted relative to the “2-2-2” kinematic coupling as shown in FIG. 23, such that the Z axis of the measurement probe 14 is substantially within the plane of the three locations 31, 32, 33 of the coupling arrangement 30. This can be referred to as a side-mounted configuration (with the probe 14 being mounted to the side of part 10), compared to the bottom-mounted configuration of FIG. 20 (with the probe 14 being mounted to the bottom of part 10). With such a mounting configuration, an overtravel in the Z direction would also unseat the coupling arrangement 30, causing the parts thereof to lift away from the seated position (out of the page of the drawing) and rotate around (within the page of the drawing), for example around a centrally-located retaining pin that provides constrained rotation (but which has sufficient clearance such that it does not provide any additional points of contact when the coupling is properly seated). A biasing member (e.g. spring) could be provided to return the coupling back to the seated position.

Whilst the “2-2-2” coupling arrangement 30 of FIG. 20 would not provide a kinematically-defined axis of rotation during the decoupling process, as is the case with the previous embodiments based on a “1-2-3” configuration, the “2-2-2” configuration does have the benefit of having a three-fold rotational symmetry (at least if the three locations 31, 32, 33 are arranged as an equilateral triangle), thereby enabling it to decouple (e.g. rock) more uniformly with a knock from any direction than would be the case with the “1-2-3” kinematic arrangement which has only 1-fold rotational symmetry. With an appropriate design it can still be ensured that the two halves decouple from one another in an orderly manner, whilst also ensuring that they are guided back into the seated “2-2-2” kinematic location after the decoupling event.

A suitable catch mechanism can also be provided, along the lines of what is described in relation to previous embodiments, to ensure that the two halves do not come away completely from one another. A simple schematic illustration of one possibility for this is shown in FIG. 24, in which a post 41 fixed rigidly to part 10 projects through a bore 42 formed through part 20, such that when the coupling becomes unseated as part of an overtravel event the part 10 pivots on a back corner or edge against part 20 but only up to a stop position created by contact on the other side of part 20 with the post 41 as is illustrated in FIG. 25. This prevents part 10 coming away from part 20 completely, such that it can become reseated (appropriate guidance means, not shown, can be provided to assist reseating). When in the seated position as shown in FIG. 24, the two parts 10, 20 can be separated from one another by lifting part 10 directly away from part 20 without relative rotation, with post 41 being sized to fit through bore 42. Furthermore, in the seated position there is clearance between the post 41 and the sides of the bore 42, so as not to create any additional points of contact which would otherwise lead to inexact (or non-kinematic) constraint.

For any of the above-described embodiments it would be possible (and beneficial in many circumstances) to mount the coupling arrangement 30 to the robot 1 via a further kinematic coupling, for example so that it can be used in an automated and interchangeable manner with other tools and attachments (such as with the “autochange system” from Renishaw plc). For example, FIG. 26 is a schematic illustration of a variation of the embodiment of FIG. 8, in which an additional kinematic coupling 36 is provided between part 20 (of the coupling arrangement 30) and the flange 3 of the robot arm 1. This would enable the coupling arrangement 30 (with or without the probe 14 attached) to be easily and readily interchanged (as a unit) with other tools (including other types of measurement probe), for example from an autochange rack. This concept can be extended to any of the other embodiments. It should be noted that, in the arrangement shown in FIG. 26, for a particular type of probe 14 there would effectively be three kinematic couplings arranged in line: the first being provided internally to the probe 14 as part of the measurement function of the probe 14 (as described above), the second being provided as part of the coupling arrangement 30, and the third being provided by the additional kinematic coupling 36.

As already mentioned above, it will also be appreciated that a reverse kinematic coupling arrangement is used internally for some designs of touch trigger probes, but that is used as an inherent part of the design for the touch detection rather than as a form of over-travel protection per se. The kinematic coupling arrangement inside a touch trigger probe must be very repeatable and accurate, with high sensitivity to touch, and therefore is a low-force kinematic, i.e. it is not heavily loaded. It must also be sealed against the environment to prevent dust and other debris coming between the two halves of the kinematic. This also means that, to remain low weight, the probe housing must be very compact, which is anyway a desirable feature of a probe. Therefore, the range of travel is very low, and does not provide any meaningful protection against over-travel in the Z direction (i.e. along the stylus). Where reference is made (in the literature for these devices) to “over-travel”, this is more a reference to an amount of travel that is greater than the theoretical minimum travel of zero, and is considered herein to amount to a normal range of travel for the probe rather than over-travel per se.

An embodiment of the present invention is intended to be used in conjunction with such a touch trigger probe, to provide over-travel protection for the measurement probe in addition to and independent of any “over-travel” which the measurement probe is described as having inherently as part of its design. Furthermore, because a coupling arrangement embodying the present invention is not primarily used for metrology purposes, it can accordingly be more robust and more highly loaded. Because of the higher loading, compared to that for a kinematic inside a contact probe, debris making its way into the coupling is not such a problem and accordingly a coupling arrangement embodying the present invention does not need to be sealed.

Purely by way of rough comparison, and in no way intended to be limiting, the LP2 probe mentioned above typically has around 6.5 mm of available travel in the Z direction (as part of the touch triggering function in this direction), whereas a coupling arrangement embodying the present invention might typically provide at least 30 mm of over-travel protection for such a probe, i.e. in addition to any available travel provided by the design of the probe itself. A typical stylus for the LP2 probe has a length of between 50 mm and 100 mm, but pivots within the probe body (in X, Y directions) around 20 mm beyond the top end of the stylus, so that the effective or representative length is between 70 mm and 120 mm. The travel allowed by such a probe design in the Z direction is therefore of the order of 5% to 9% of the representative length, whereas a coupling arrangement would allow over-travel more of the order of 25% to 45% of the representative length (but could be more with a different design). This comparison is purely illustrative, and the exact values would depend entirely on the application concerned and the probe system used.

It will be appreciated that the present invention is applicable to types of device other than a measurement device, for example other than just a measurement probe 14 as described above, and is applicable more widely to any device that is couplable to a coordinate positioning machine and which would benefit from over-travel protection. This applies both to contact devices, which are designed to come into contact with an object in order to perform their intended function, and therefore perhaps most likely to need over-travel protection, but also applies to non-contact devices because even if contact is not required for normal operation this does not mean that machine operation errors will not sometimes inadvertently cause contact between the device and an immovable object nonetheless. It will also be appreciated that the present invention is applicable to types of coordinate positioning machine other than a robot arm, for example a three-axis Cartesian coordinate measuring machine, a non-Cartesian hexapod coordinate positioning machine, a delta robot, a Selective Compliance Assembly Robot Arm (SCARA), and so on.

1. A coupling arrangement for coupling a measurement device to a coordinate positioning machine, wherein the coupling arrangement is adapted to provide over-travel protection for the device when the device is moved relative to the coupling arrangement towards an interface therebetween.

2. A coupling arrangement as claimed in claim 1, wherein the coupling arrangement is adapted to provide over-travel protection by causing the device to become at least partially decoupled from the machine.

3. A coupling arrangement as claimed in claim 2, wherein the coupling arrangement is adapted such that the device remains partially coupled to the machine when in an over-travel state.

4. A coupling arrangement as claimed in claim 2, wherein the coupling arrangement is adapted such that the device remains coupled to the machine in at least one degree of freedom when in an over-travel state.

5. A coupling arrangement as claimed in claim 2, wherein the coupling arrangement is adapted such that the device becomes decoupled from the machine in a single degree of freedom, for example a rotational degree of freedom, and remains coupled to the machine in the other five degrees of freedom when in an over-travel state.

6. (canceled)

7. A coupling arrangement as claimed in claim 2, wherein the coupling arrangement is adapted to recouple the device to the machine, when no longer in an over-travel state, in the same relative position and orientation as it was before becoming at least partially decoupled.

8. A coupling arrangement as claimed in claim 1, wherein the coupling arrangement is adapted to provide over-travel protection along a predetermined axis of the measurement device, where the predetermined axis is one or more of: a Z axis of the measurement device; a generally longitudinal axis of the measurement device; and an axis of the measurement device having the smallest available travel.

9. A coupling arrangement as claimed in claim 1, wherein the coupling arrangement is adapted to provide a kinematic or pseudo-kinematic coupling between the device and machine.

10. A coupling arrangement as claimed in claim 1, wherein the coupling arrangement defines six points of contact which are mutually arranged to constrain the device relative to the machine in six corresponding degrees of freedom, wherein the six points of contact may be arranged across three locations in a “1-2-3” configuration or a “2-2-2” configuration.

11-13. (canceled)

14. A coupling arrangement as claimed in claim 10, wherein the points of contact are offset from a predetermined axis of the measurement device and/or wherein a plane defined by the points of contact is arranged at an angle to a predetermined axis of the measurement device, wherein the angle may be an acute angle, for example between 20 and 70 degrees, for example between 35 and 55 degrees, for example approximately 45 degrees.

15. (canceled)

16. A coupling arrangement as claimed in claim 1, comprising a retaining mechanism which is adapted to prevent the device from falling off and/or away from the machine completely, wherein the retaining mechanism may be adapted to allow removal of the device from the machine only when in a predetermined relative orientation.

17-19. (canceled)

20. A coupling arrangement as claimed in claim 1, wherein the measurement device is a measurement probe or a contact measurement device such as a touch trigger measurement probe.

21-25. (canceled)

26. A coupling arrangement as claimed in claim 1, wherein the coupling arrangement is adapted to cause the measurement device to become at least partially decoupled from the machine only after the measurement device has triggered a measurement.

27. A coupling arrangement as claimed in claim 1, wherein the measurement device comprises a sensor or transducer which is adapted to sense or measure relative movement between two parts of the measurement device in order to perform a measurement function, the sensor or transducer being operable within a predetermined range of forces and/or a within a predetermined range of travel, and the coupling arrangement having a coupling force greater than the predetermined range of forces and/or a range of travel greater than the predetermined range of travel.

28. A coupling arrangement as claimed in claim 1, wherein the measurement device provides a first coupling, having a first coupling force and/or a first range of travel, with the coupling arrangement providing a second coupling, having a second coupling force greater than the first coupling force and/or a second range of travel greater than the first range of travel.

29. A coupling arrangement as claimed in claim 28, wherein the measurement device is a contact measurement device such as a touch trigger measurement probe, and wherein the measurement device comprises a stylus and a stylus support, and wherein the first coupling is a coupling, such as a kinematic coupling, which couples the stylus internally to the stylus support.

30. A coupling arrangement as claimed in claim 1, comprising a kinematic or pseudo-kinematic coupling for coupling the coupling arrangement to the machine.

31. (canceled)

32. A kit comprising a measurement device and a coupling arrangement as claimed in claim 1.

33. A coordinate positioning machine comprising a measurement device coupled to the machine via a coupling arrangement as claimed in claim 1.

34. (canceled)

35. (canceled)

36. A machine as claimed in claim 33, wherein the coordinate positioning machine is or comprises a robot arm.

37. (canceled)
